(19) United States
(12) Patent Application Publication
(10) Pub. No.: US 2012/0216764 A1
(43) Pub. Date: Aug. 30, 2012

(54) ENGINE COOLING SYSTEM AND MOTOR THEREFOR

(76) Inventors: Rui Feng QIN, Hong Kong (CN); Tao QU, Shenzhen (CN); Xin Hui GUAN, Shenzhen (CN)

(21) Appl. No.: 13/404,948

(22) Filed: Feb. 24, 2012

(30) Foreign Application Priority Data
Feb. 25, 2011 (CN) 201110046414.4

(51) Int. Cl. F01P 5/04; F04B 35/04; H01R 39/415

(52) U.S. Cl. 123/41.49; 310/245; 417/423.7

(57) ABSTRACT

A cooling module for an engine includes an electric motor and an impeller driven by the motor. The motor includes a stator having brush assemblies, and a rotor having a commutator. Each of the brush assemblies includes a brush holder, a brush slidably received in the brush holder, and a spring. The spring includes a mounting portion, a coiled portion and an elongated unrolled section joining the mounting portion to the coiled portion. The mounting portion is fixed to the brush holder and located closer to the commutator than the coiled portion. The coiled portion presses against a radially outer end of the brush to push the brush towards the commutator. The brush forms a concave for accommodating the coiled portion of the spring. The unrolled section is coiled into the coiled portion as the length of the brush is reduced.

### CROSS REFERENCE TO RELATED APPLICATIONS

This non-provisional patent application claims priority under 35 U.S.C. §119(a) from Patent Application No. 201110046414.4 filed in The People's Republic of China on Feb. 25, 2011.

### FIELD OF THE INVENTION

This invention relates to an engine cooling system, and in particular, to an electric motor for the engine cooling system.

### BACKGROUND OF THE INVENTION

An engine cooling system typically includes a motor and an impeller or fan driven by the motor. The motor includes a stator and a rotor. The stator includes a number of brushes slidably contacting a commutator of the rotor. Since the brushes wear during operation, the brushes each are elongated to prolong the life of the motor. Additionally, the brushes each are urged by a spring towards the commutator. As the brush wears, the spring urges the brush towards the commutator to assure good contact between the brush and the commutator. However, the force provided by the spring is too strong in the initial working period of the motor, accelerating the wearing of the brush. In contrast, the force provided by the spring is too weak in the later working period of the motor, whereby the brush is not pressed against the commutator with sufficient force, resulting in a bad contact between the brush and the commutator.

Therefore, there is a need for an improved motor which can overcome the above described shortcomings.

### SUMMARY OF THE INVENTION

Accordingly, in one aspect thereof, the present invention provides an engine cooling system comprising: an engine; a coolant tank; a radiator; a plurality of connecting pipes connecting the engine, the coolant tank and the radiator to form a loop; and a cooling module for cooling the radiator, the cooling module comprises a motor and an impeller driven by the motor, the motor comprising a stator and a rotor rotatably mounted confronting the stator, the rotor comprising a shaft and a commutator fitted to the shaft, the stator comprising a plurality of brush assemblies, each of the brush assemblies comprising a brush holder, a brush slidably received in the brush holder, and a spring, the spring comprising an elongated unrolled section, a mounting portion adjoining one end of the unrolled section, and a coiled portion adjoining an opposite end of the unrolled section, the mounting portion being fixed to the brush holder and located closer to the commutator than the coiled portion, the coiled portion pressing against a radially outer end of the brush to urge the brush towards the commutator, the unrolled section being able to be coiled into the coiled portion as the length of the brush is reduced, the brush having a concave for accommodating the coiled portion of the spring.

Preferably, the concave of the brush has a curved projection on a plane perpendicular to a rotational axis of the motor.

Preferably, the brush comprises a lead wire extending outwardly, the lead wire and the unrolled section of the spring are located at opposite lateral sides of the brush.

Preferably, the stator further comprises an end cap and a brush card fixed to the end cap, and the brush assemblies are fixed to the brush card.

Preferably, the brush holder comprises a plurality of hooks which clasp the brush card to fix the brush holder to the brush card.

Preferably, the stator comprises two chokes mounted on the brush card.

Preferably, the motor comprises a power cable having a positive wire and a negative wire, one of the chokes is electrically connected between the positive wire and a corresponding brush, and the other choke is electrically connected between the negative wire and a corresponding brush.

Preferably, the stator further comprises a capacitor electrically connected between the positive wire and the negative wire of the power cable.

Preferably, the stator further comprises a housing and two grounding capacitors each connecting a respective one of the positive wire and the negative wire to the housing.

According to a second aspect, the present invention provides a cooling module for an engine cooling system, comprising: an impeller; and a motor driving the impeller, the motor comprising a stator and a rotor rotatably mounted confronting the stator, the rotor comprising a shaft and a commutator fitted to the shaft, the stator comprising a plurality of brush assemblies, each of the brush assemblies comprising a brush holder, a brush slidably received in the brush holder, and a spring, the spring comprising an elongated unrolled section, a mounting portion adjoining one end of the unrolled section, and a coiled portion adjoining an opposite end of the unrolled section, the mounting portion being fixed to the brush holder and located closer to the commutator than the coiled portion, the coiled portion pressing against a radially outer end of the brush to push the brush towards the commutator, the unrolled section being able to be coiled into the coiled portion as the length of the brush is reduced, the brush having a concave for accommodating the coiled portion of the spring.

Preferably, the concave of the brush has a curved projection on a plane perpendicular to a rotational axis of the motor.

Preferably, the brush comprises a lead wire extending outwardly, the lead wire and the unrolled section of the spring are located at opposite lateral sides of the brush.

Preferably, the stator further comprises an end cap and a brush card fixed to the end cap, and the brush assemblies are fixed to the brush card.

Preferably, the brush holder comprise a plurality of hooks which clasp the brush card to fix the brush holder to the brush card.

According to a third aspect, the present invention provides an electric motor for an engine cooling system, comprising: a stator comprising a plurality of brush assemblies, each of the brush assemblies comprising a brush holder, a brush slidably received in the brush holder, and a spring, the spring comprising a mounting portion, a coiled portion and an elongated unrolled section extending between the mounting portion and the coiled portion, the mounting portion being fixed to the brush holder, the coiled portion pressing against a radially outer end of the brush, the unrolled section being able to be coiled into the coiled portion as the length of the brush is reduced, the brush having a concave for accommodating the coiled portion of the spring; and a rotor rotatably mounted confronting the stator, the rotor comprising a shaft and a commutator fitted to the shaft; wherein the mounting portion of the spring is located closer to the commutator than the coiled portion.

Preferably, the concave of the brush has a curved projection on a plane perpendicular to a rotational axis of the motor.

Preferably, the brush comprises a lead wire extending outwardly, the lead wire and the unrolled section of the spring are located at opposite lateral sides of the brush.

Preferably, the stator further comprises an end cap and a brush card fixed to the end cap, and the brush assemblies are fixed to the brush card.

Preferably, the brush holder comprises a plurality of hooks which clasp the brush card to fix the brush holder to the brush card.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a schematic diagram of an engine cooling system according to an embodiment of the present invention;

FIG. 2 is an isometric view of a motor of the engine cooling system of FIG. 1;

FIG. 3 shows a commutator and an end cap of the motor of FIG. 2;

FIG. 4 shows the commutator and brush assemblies of the end cap of FIG. 3, but with a brush holder of one brush assembly removed;

FIG. 5 shows a brush assembly of FIG. 4; and

FIG. 6 shows a brush assembly with the brush holder omitted..

### DETAILED DESCRIPTION OF THE PREFERRED EMBODIMENTS

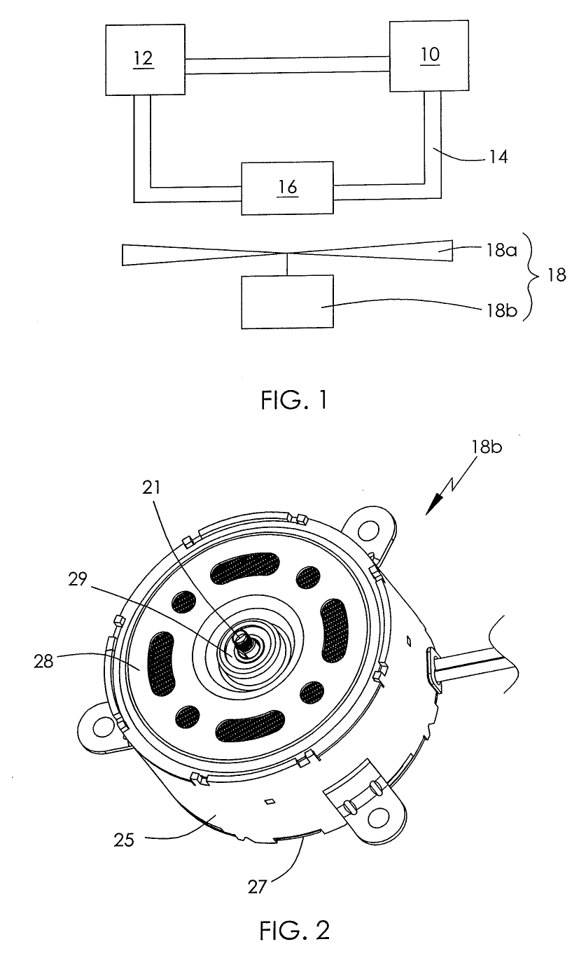

Referring to FIG. 1, an engine cooling system according to the preferred embodiment of the present invention includes a coolant tank 10, an engine 12, a radiator 16, a cooling module 18 for cooling the radiator 16, and a number of connecting pipes 14 connecting the coolant tank 10, the engine 12, and the radiator 16 to form a heat dissipation loop. The coolant tank 10 is filled with coolant such as water. The coolant, driven by a pump (not shown) flows from the coolant tank 10 and enters cooling channels in the engine 12 and absorbs heat from the engine 12, and then the coolant flows through the radiator 16 where the coolant releases its heat, then the coolant returns back to the coolant tank 10 via the connecting pipes 14 for another cycle. The cooling module 18 removes heat from the radiator 16 such that the radiator 16 is able to continuously absorb heat from the coolant.

The cooling module 18 includes a motor 18b and an impeller or fan 18a driven by the motor 18b. The impeller 18a is rotated to produce an airflow flowing through the radiator 16.

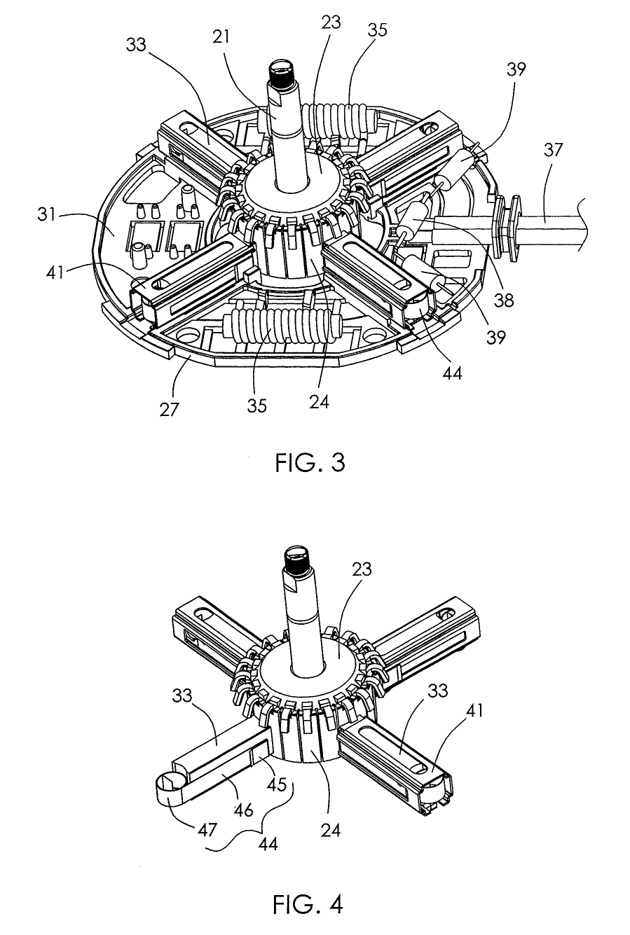

Referring to FIGS. 2 and 3, the motor 18b includes a stator and rotor rotatably mounted confronting the stator. The rotor includes a shaft 21, a rotor core (not shown) and a commutator 23 fitted to the shaft 21, and a plurality of windings wound around the rotor core. The commutator 23 includes a plurality of segments 24 to which the windings are terminated.

The stator includes a housing 25, a number of permanent magnets (not shown) attached to an inner surface of the housing 25. An end cap 27 is connected to an open end of the housing 25, a plurality of brush assemblies (four in this embodiment) are mounted on the end cap 27, and a bearing 29 mounted on the end cap 27. A second end cap 28 is connected to a second open end of the housing.

The brush assemblies are mounted on a mounting frame or brush card 31 which is fixed to the end cap 27. Each brush assembly includes a brush holder 41 mounted on the brush card 31, a brush 33 slidably received in the brush holder 41, and a spring 44 pressing against the brush 33. The brush 33 is arranged in such a manner that a radially inner end thereof slidably contacts the segments 24 of the commutator 23.

A power cable 37 is electrically connected with the brushes 33 to supply power to the motor 18b. The end cap 27 further includes electromagnetic compatibility (EMC) components. The EMC components suppress electromagnetic interference produced by the motor to improve the electromagnetic compatibility level of the motor 18b. The EMC components include two chokes 35, a first capacitor 38 and two second capacitors 39. One choke 35 is electrically connected between a corresponding pair of brushes 33 and a positive wire of the power cable 37. The other choke 35 is electrically connected between the other pair of brushes 33 and a negative wire of the power cable 37. The first capacitor 38 is electrically connected between the positive wire and the negative wire of the power cable 37. The second capacitors 39 are grounding capacitors, and each of the second capacitors 39 electrically connect a respectively one of the positive wire and the negative wire of the power cable 37 to the housing 25 of the motor 18b. It can be understood that the number of the chokes and the capacitors may vary for different needs.

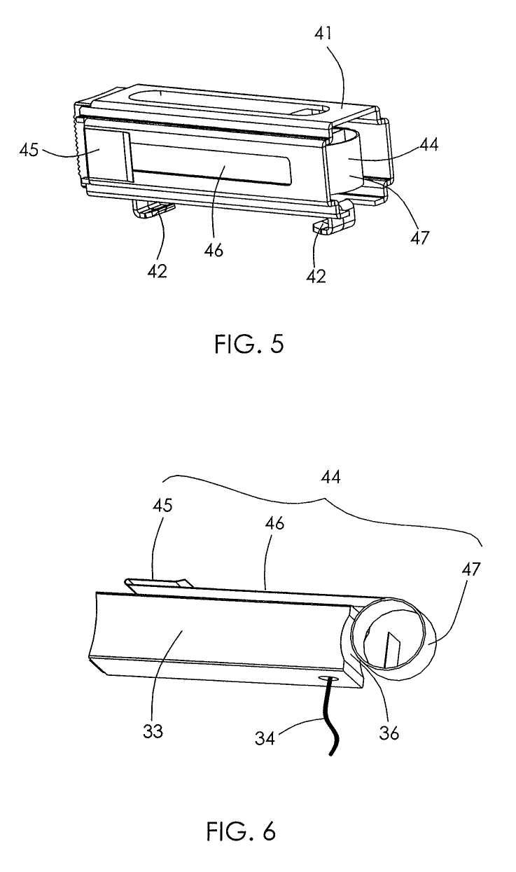

Referring also to FIGS. 4 and 5, the spring 44 includes a mounting portion 45, an unrolled section 46, and a coiled portion 47. The unrolled section 46 is elongated, and extends between the mounting portion 45 and the coiled portion 47. The mounting portion 45 is arranged closer to the commutator 23 than the coiled portion 47. The mounting portion 45 is fixed to the brush holder 41. Conveniently, the mounting portion 45 is u-shaped and clips on to an edge of the brush holder at the open end adjacent the commutator and the unrolled section 46 extends along the brush in a gap between the brush and the brush holder. The coiled portion 47 is annular, and the unrolled section 46 can be coiled in the coiled portion 47.

The coiled portion 47 of the spring 44 bears against a radially outer end of the brush 33 to push the brush 33 towards the commutator 23. As the brush 33 wears, the length of the brush 33 is reduced, and the coiled portion 47 of the spring 44 moves towards the commutator 23, thereby recoiling a portion of the unrolled section 46. In this way, the spring 44 provides a substantially constant force against the radially outer end of the brush 33 as the length of the brush 33 reduces.

As shown in FIG. 5, the brush holder 41 of the present embodiment includes two hooks 42, which clasp the brush card 31 to fix the brush holder 41 to the brush card 31.

Referring to FIG. 6, the outer end of the brush 33 forms a concave 36 to define a receiving space for accommodating the coiled portion 47 of the spring 44. Preferably, the concave 36 has a curved projection on a plane perpendicular to an rotation axis of the motor 18b. The coiled portion 47 of the spring 44 has an outer surface conforming to the concave 36 of the brush 33, such that vibration of the brush 33 can be reduced. Alternatively, the projection of the concave 36 can be polygonal shaped with an opening for allowing the coiled portion 47 of the spring 44 to enter into the receiving space, for example, the projection of the concave 36 can be rectangular shaped or trapezoidal shaped.

A shunt or lead wire 34 of the brush 33 extends out of the brush 33. The lead wire 34 and the unrolled section 46 of the spring are located at two opposite lateral sides of the brush 33, such arrangement makes use of space between two neighboring brushes 33, and thereby reducing the axial length of the motor 18b, which is important in the cooling engine system.

Although the invention is described with reference to one or more preferred embodiments, it should be appreciated by those skilled in the art that various modifications are possible. Therefore, the scope of the invention is to be determined by reference to the claims that follow. It should be noted that although the coolant tank of the engine cooling system has been described as though it is a separate independent item, in practice the coolant tank may be formed as a part of the radiator.

In the description and claims of the present application, each of the verbs “comprise”, “include”, “contain” and “have”, and variations thereof, are used in an inclusive sense, to specify the presence of the stated item but not to exclude the presence of additional items.

1. An engine cooling system comprising:
an engine;
a coolant tank;
a radiator;
a plurality of connecting pipes connecting the engine, the coolant tank and the radiator to form a loop; and
a cooling module for cooling the radiator, the cooling module comprises a motor and an impeller driven by the motor, the motor comprising a stator and a rotor rotatably mounted confronting the stator, the rotor comprising a shaft and a commutator fitted to the shaft, the stator comprising a plurality of brush assemblies, each of the brush assemblies comprising a brush holder, a brush slidably received in the brush holder, and a spring, the spring comprising an elongated unrolled section, a mounting portion adjoining one end of the unrolled section, and a coiled portion adjoining an opposite end of the unrolled section, the mounting portion being fixed to the brush holder and located closer to the commutator than the coiled portion, the coiled portion pressing against a radially outer end of the brush to urge the brush towards the commutator, the unrolled section being able to be coiled into the coiled portion as the length of the brush is reduced, the brush having a concave for accommodating the coiled portion of the spring.

2. The engine cooling system of claim 1, wherein the concave of the brush has a curved projection on a plane perpendicular to a rotational axis of the motor.

3. The engine cooling system of claim 1, wherein the brush comprises a lead wire extending outwardly, the lead wire and the unrolled section of the spring are located at opposite lateral sides of the brush.

4. The engine cooling system of claim 1, wherein the stator further comprises an end cap and a brush card fixed to the end cap, and the brush assemblies are fixed to the brush card.

5. The engine cooling system of claim 4, wherein the brush holder comprises a plurality of hooks which clasp the brush card to fix the brush holder to the brush card.

6. The engine cooling system of claim 4, wherein the stator comprises two chokes mounted on the brush card.

7. The engine cooling system of claim 6, wherein the motor comprises a power cable having a positive wire and a negative wire, one of the chokes is electrically connected between the positive wire and a corresponding brush, and the other choke is electrically connected between the negative wire and a corresponding brush.

8. The engine cooling system of claim 7, wherein the stator further comprises a capacitor electrically connected between the positive wire and the negative wire of the power cable.

9. The engine cooling system of claim 1, wherein the stator further comprises a housing and two grounding capacitors each connecting a respective one of the positive wire and the negative wire to the housing.

10. A cooling module for an engine cooling system, comprising:
an impeller; and
a motor driving the impeller, the motor comprising a stator and a rotor rotatably mounted confronting the stator, the rotor comprising a shaft and a commutator fitted to the shaft, the stator comprising a plurality of brush assemblies, each of the brush assemblies comprising a brush holder, a brush slidably received in the brush holder, and a spring, the spring comprising an elongated unrolled section, a mounting portion adjoining one end of the unrolled section, and a coiled portion adjoining an opposite end of the unrolled section, the mounting portion being fixed to the brush holder and located closer to the commutator than the coiled portion, the coiled portion pressing against a radially outer end of the brush to push the brush towards the commutator, the unrolled section being able to be coiled into the coiled portion as the length of the brush is reduced, the brush having a concave for accommodating the coiled portion of the spring.

11. The cooling module of claim 10, wherein the concave of the brush has a curved projection on a plane perpendicular to a rotational axis of the motor.

12. The cooling module of claim 10, wherein the brush comprises a lead wire extending outwardly, the lead wire and the unrolled section of the spring are located at opposite lateral sides of the brush.

13. The cooling module of claim 10, wherein the stator further comprises an end cap and a brush card fixed to the end cap, and the brush assemblies are fixed to the brush card.

14. The cooling module of claim 13, wherein the brush holder comprise a plurality of hooks which clasp the brush card to fix the brush holder to the brush card.

15. An electric motor for an engine cooling system, comprising:
a stator comprising a plurality of brush assemblies, each of the brush assemblies comprising a brush holder, a brush slidably received in the brush holder, and a spring, the spring comprising a mounting portion, a coiled portion and an elongated unrolled section extending between the mounting portion and the coiled portion, the mounting portion being fixed to the brush holder, the coiled portion pressing against a radially outer end of the brush, the unrolled section being able to be coiled into the coiled portion as the length of the brush is reduced, the brush having a concave for accommodating the coiled portion of the spring; and
a rotor rotatably mounted confronting the stator, the rotor comprising a shaft and a commutator fitted to the shaft;
wherein the mounting portion of the spring is located closer to the commutator than the coiled portion.

16. The motor of claim 15, wherein the concave of the brush has a curved projection on a plane perpendicular to a rotational axis of the motor.

17. The motor of claim 15, wherein the brush comprises a lead wire extending outwardly, the lead wire and the unrolled section of the spring are located at opposite lateral sides of the brush.

18. The motor of claim 15, wherein the stator further comprises an end cap and a brush card fixed to the end cap, and the brush assemblies are fixed to the brush card.

19. The motor of claim 18, wherein the brush holder comprises a plurality of hooks which clasp the brush card to fix the brush holder to the brush card.
